(19) United States
(12) Patent Application Publication
(10) Pub. No.: US 2016/0233575 A1
(43) Pub. Date: Aug. 11, 2016

(54) Antenna Device and Terminal

(71) Applicant: ZTE CORPORATION, Shenzhen (CN)

(72) Inventor: Qun LI, Shenzhen (CN)

(21) Appl. No.: 15/023,754

(22) PCT Filed: May 21, 2014
(86) PCT No.: PCT/CN2014/078044

§ 371 Date: Mar. 22, 2016

(30) Foreign Application Priority Data
Sep. 23, 2013 (CN) 201310444354.0

(51) Int. Cl. H01Q 1/24; H01Q 1/48; H01Q 9/42

(52) U.S. Cl. CPC H01Q 1/243; H01Q 9/42; H01Q 1/48

(57) ABSTRACT

An antenna device and a terminal are provided wherein an antenna body of the antenna device includes an antenna radiation body, and a first feed part and a first grounding part arranged on the antenna radiation body. The first feed part and the first grounding part are separately arranged on a same side of the antenna radiation body. The device further includes a gap between the first feed part and the first grounding part forming a groove configured to adjust a low-frequency bandwidth. The groove with a certain width is formed between the feed part and the grounding part of the antenna body, so that the low-frequency bandwidth of the antenna can be adjusted by adjusting the width of the groove. By increasing the low-frequency bandwidth of the antenna, the energy loss when the antenna of the terminal gets close to a body part of the user is reduced.

### TECHNICAL FIELD

The present disclosure relates to the field of communications, and in particular to an antenna device and a terminal.

### BACKGROUND

The determination of the transmitting power of a communication terminal such as a mobile phone is designed to be more and more complicated in such protocols as Global System for Mobile Communications (GSM), Code Division Multiple Access (CDMA) 20001× and Wideband Code Division Multiple Access (WCDMA), and obviously, the determination of the transmitting power is of great importance. However, there is a problem that which one is better for us, higher transmitting power or lower transmitting power of the mobile phone. Actually, it is not a wise answer to simply say the higher the better or the lower the better, as two aspects below need to be considered during design of the power of the mobile phone.

1. Under a Premise of Guaranteeing Normal Communication, the Lower the Transmitting Power of the Mobile Phone the Better

On one hand, if the transmitting power of the mobile phone is lower, the power consumption of the mobile phone is lower, and the standby time and the talk time are longer. On the other hand, if the transmitting power of the mobile phone is lower, the interference on other mobile phones in the same system is lower, which not only creates a good wireless environment for other mobile phones in the same system, but also provides a high cell capacity for CDMA20001× and WCDMA. In addition to the above, if the transmitting power of the mobile phone is lower, the interference on other wireless equipment is lower, and this creates a good wireless environment for other wireless equipment.

2. In Some Cases, to Guarantee the Communication Quality, the Transmitting Power of the Mobile Phone Needs to be Increased

When the mobile phone is located at the far end of a cell, to ensure that a signal of a mobile phone can still be correctly demodulated after reaching a base station via long-distance transmission, the transmitting power of the mobile phone needs to be high enough to overcome attenuation, caused by long-distance transmission, of the signal. Furthermore, if the signal of the mobile phone is blocked by a building or other obstacles, the transmitting power of the mobile phone needs to be high enough in a wireless shadow area to overcome attenuation, caused by reflection, refraction and long-distance transmission for multiple times, of the signal of the mobile phone. Under a condition of higher interference, such as interference and blocking between adjacent channels or interference and blocking within the current channel, the transmitting power of the mobile phone also needs to be high enough to overcome interference of noise.

In conclusion, there are two aspects to be considered for the determination of the transmitting power of the mobile phone. On one hand, under the premise of guaranteeing the normal communication, the lower the transmitting power of the mobile phone the better; on the other hand, in some cases, to guarantee the communication quality, the transmitting power of the mobile phone needs to be improved continuously. Such two aspects seem to be contradictory, but are actually uniform, and a more accurate description for this would be: the mobile phone should have high enough power to guarantee the communication quality; on the premise of guaranteeing the communication quality, the lower the transmitting power of the mobile phone the better. In other words, the transmitting power of the mobile phone had better be controlled according to the actual situation, specifically, when high transmitting power is needed, the transmitting power of the mobile phone is increased, and when low transmitting power is needed, the transmitting power of the mobile phone is decreased. Generally, a traditional antenna of a mobile terminal has good OTA performance under a state of a free space. However, during actual use of the mobile terminal by a user, a hand or the head of the user may get close to the terminal, and this may change the radiation field of the antenna. Part of energy is absorbed away, and part of energy deviates from a given radiation frequency band, so that the receiving performance and the radiation performance of the mobile phone are reduced, and the satisfaction degree of user experience is lowered.

### SUMMARY

The embodiments of the present disclosure provide an antenna device and a terminal, so as to solve the problem that the satisfaction degree of user experience is lowered as the receiving performance and radiation performance are reduced when the antenna device of an existing terminal gets close to a part of the body of a user.

To solve the technical problem, an embodiment of the present disclosure provides an antenna device, including an antenna body, wherein the antenna body includes an antenna radiation body, and a first feed part and a first grounding part which are arranged on the antenna radiation body; the first feed part and the first grounding part are separately arranged on a same side of the antenna radiation body, and a gap between the first feed part and the first grounding part forms a groove configured to adjust a low-frequency bandwidth.

In one embodiment of the present disclosure, the antenna radiation body includes a first radiation support arm and a second radiation support arm; after being connected in parallel at one ends of the first radiation support arm and the second radiation support arm, the first radiation support arm and the second radiation support arm, as a whole, are connected with the first feed part and the first grounding part respectively; the other ends of the first radiation support arm and the second radiation support arm respectively extend along a same direction.

In one embodiment of the present disclosure, after the other ends of the first radiation support arm and the second radiation support arm respectively extend along the same direction, the first radiation support arm and the second radiation support arm may be combined to form an inverted G shape.

In one embodiment of the present disclosure, a trace length of the first radiation support arm may be greater than a trace length of the second radiation support arm.

In one embodiment of the present disclosure, the antenna device may further include a main board, a radio frequency circuit module arranged on the main board, and a second feed part and a second grounding part which are separately arranged on the main board; the first feed part and the first grounding part are respectively connected with the second feed part and the second grounding part; the second feed part is connected with the radio frequency circuit module.

In one embodiment of the present disclosure, the second feed part and the second grounding part are arranged in a middle area of two sides of the main board.

In one embodiment of the present disclosure, the antenna device further includes a matching circuit module; the second feed part is connected with the radio frequency circuit module through the matching circuit module.

In one embodiment of the present disclosure, a width of the groove is greater than or equal to 0.5 mm and less than or equal to 35 mm.

To solve the problem, another embodiment of the present disclosure further provides a terminal, including the above mentioned antenna device arranged in the terminal.

In one embodiment of the present disclosure, distances between two sides of the antenna radiation body and two sides of the terminal are greater than 5 mm.

In the antenna device and the terminal provided by the embodiments of the present disclosure, the antenna body of the terminal includes an antenna radiation body, and a first feed part and a first grounding part which are arranged on the antenna radiation body; furthermore, the first feed part and the first grounding part are separately arranged on a same side of the antenna radiation body; a gap between the first feed part and the first grounding part forms a groove configured to adjust a low-frequency bandwidth, that is, the groove with a certain width is formed between the feed part and the grounding part of the antenna body, so as to adjust the low-frequency bandwidth of the antenna by adjusting the width of the groove. By increasing the low-frequency bandwidth of the antenna, the energy loss when the antenna of the terminal gets close to a part of the body (such as a hand or the head) of the user is reduced, so as to guarantee the receiving performance and the radiation performance of the antenna, and enhance the satisfaction degree of user experience.

### BRIEF DESCRIPTION OF THE DRAWINGS

FIG. 1 shows a structure diagram of an antenna device in an embodiment II of the present disclosure;

FIG. 2 shows a structure diagram of an antenna body in an embodiment II of the present disclosure;

FIG. 3 shows a diagram of a standing-wave ratio of the antenna as shown in FIG. 2; and

FIG. 4 shows an antenna radiation pattern at a horizontal plane as shown in FIG. 2.

### DETAILED DESCRIPTION OF THE EMBODIMENTS

### Embodiment I

An antenna device in this embodiment may be applied to any communication terminal needing an antenna, for example, may be applied to a mobile communication terminal such as a mobile phone and an IPAD, and of course, may also be applied to other fixed terminals needing antennas. The antenna device in this embodiment includes an antenna body, a main board and a radio frequency module. The antenna body comprises an antenna radiation body, and a first feed part (a signal feed point) and a first grounding part (a grounding feed point) which are arranged on the antenna radiation body. A second feed part and a second grounding part which are respectively connected with the first feed part and the first grounding part are correspondingly arranged on the main board. The antenna radiation body is connected with the main board respectively through the first feed part and the first grounding part. In this embodiment, in order to reduce the energy loss, caused when the antenna device gets close to a human body, as much as possible, the second feed part and the second grounding part may preferably be arranged in a middle area of two sides of the main board, wherein the middle area here includes an area slightly deviating from the centre of the two sides of the main board; for example, the ⅓ width part from one side of the main board also belongs to the middle area of the two sides of the main board.

In this embodiment, the first feed part and the first grounding part of the antenna body are separately arranged on a same side of the antenna radiation body, and a gap between the first feed part and the first grounding part forms a groove configured to adjust a low-frequency bandwidth. By virtue of the adjustment of the width of the groove, the low-frequency bandwidth of the antenna can be increased, so as to enhance the radiation strength in a certain direction. When the antenna gets close to a part of a human body, for example, when a person holds a terminal with a hand, the radiation field of the antenna will be changed, part of radiation energy will be absorbed, and the resonance of the antenna will deviate. After the low-frequency bandwidth is increased, when the person holds the terminal with a hand, the antenna still has good performance within the frequency band, so the energy loss of the antenna can be reduced; therefore, the receiving performance and the radiation performance of the antenna can be guaranteed, and the satisfaction degree of user experience can be enhanced. In this embodiment, the width of the groove may be determined according to the positions of the first feed part and the first grounding part on the main board and the geometric structure of the attached antenna. Preferably, the width of the groove may be greater than or equal to 0.5 mm and less than or equal to 35 mm. If the width of the groove is less than 0.5 mm, the pattern of the radiation field of the antenna may not be affected; while if the width of the groove is too great and the area is too large, the radiation field of a high-frequency part of the antenna may be affected. Specific values of the width of the groove may be selectively set to be 0.5 mm, 2 mm, 5 mm, 10 mm, 15 mm, 20 mm, 25 mm, 30 mm, 35 mm or the like according to specific application scenarios.

In this embodiment, the antenna radiation body includes a first radiation support arm and a second radiation support arm. After being connected in parallel at one ends of the first radiation support arm and the second radiation support arm, the first radiation support arm and the second radiation support arm, as a whole, may be connected with the first feed part and the first grounding part respectively, and the other ends of the first radiation support arm and the second radiation support arm respectively extend along a same direction, and form corresponding types of antennas after extending corresponding lengths and being correspondingly folded. For example, in this embodiment, the first radiation support arm and the second radiation support arm may be combined to form an inverted G-type antenna via extending and bending, and the trace length of the first radiation support arm may be greater than that of the second radiation support arm. After extending a certain length, the other end of the first radiation support arm is bent in a roundabout manner, and then extends a certain length to form an inverted U shape; the other end of the second radiation support arm extends a certain distance along a same direction to form the inverted G-shaped antenna together with the first radiation support arm.

In this embodiment, the trace lengths of the first radiation support arm and the second radiation support arm may be specifically selected and set according to the specific application scenarios. In this embodiment, the trace length of the first radiation support arm is greater than that of the second radiation support arm. For example, in this embodiment, the second radiation support arm may be configured to generate resonance in a higher frequency band, and the first radiation support arm may be configured to generate resonances in a junior-high frequency band and a low frequency band. Specifically, the trace length of the second radiation support arm may be set to be ¼ of the wavelength of the centre point of a first preset frequency band, and the first preset frequency band at that time may be a high frequency band, for example, may be set as a frequency band from 1,710 MHZ to 2,700 MHZ. The trace length of the first radiation support arm may be set to be ¼ of the wavelength of the centre point of a second preset frequency band, and the second preset frequency band at that time may be a junior-high frequency band and a low frequency band, for example, may be set as a frequency band from 824 MHZ to 960 MHZ.

In this embodiment, to better adjust the impedance of each wave band, the antenna may be further provided with a matching circuit; the first feed part of the antenna is connected with the radiation module through the matching circuit. The impedance of each wave band may be adjusted by the matching circuit, so that the wave band has a better matching output to achieve optical radiation.

### Embodiment II

An antenna device provided by this embodiment of the present disclosure is applicable for various communication terminals, for example, various mobile communication terminals such as a mobile phone and an IPAD, and is specifically arranged in each terminal. To further reduce the influence, caused when an antenna of the terminal gets close to a part of a human body, on the antenna, when an antenna body of the antenna device in this embodiment is arranged within the terminal, certain distances are preferably reserved between two sides of an antenna radiation body and two sides of the terminal, specifically, the distances between two sides of the antenna radiation body and two sides of the terminal are preferably greater than 5 mm. To better understand the embodiment of the present disclosure, a specific antenna is further described below with the accompanying drawings.

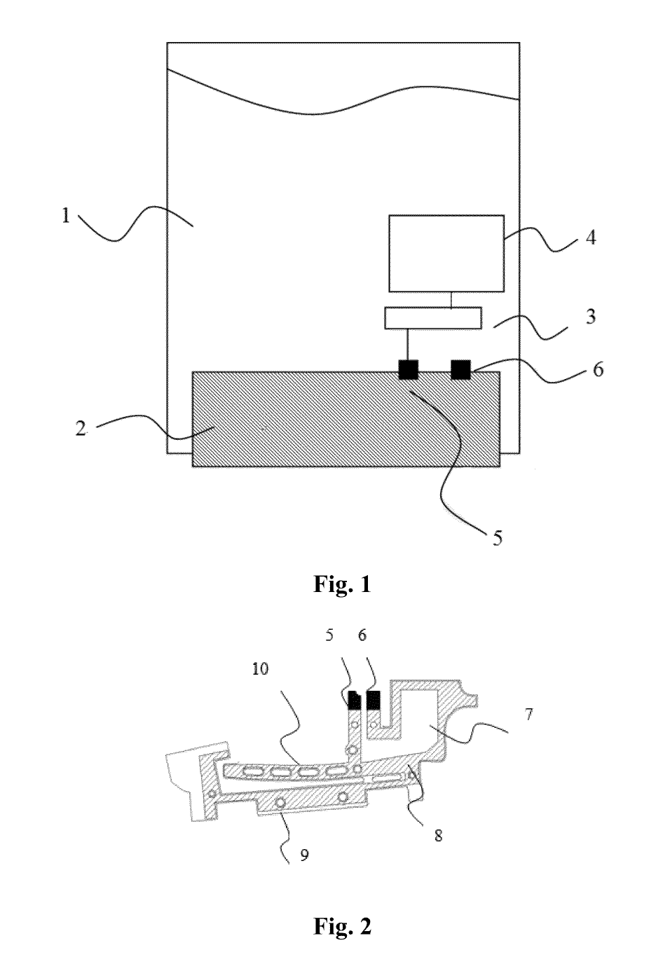

With reference to FIG. 1, an antenna device in this embodiment includes an antenna body 2, a matching circuit 3, a radio frequency module 4 and a main board 1. The antenna body 2 is connected to the main board 1 through a feed part 5 and a grounding part 6, and the matching circuit 3 is arranged between the feed part 5 and the radio frequency module 4, to assist in tuning the antenna body 2.

In this embodiment, after being connected on the main board, the feed part 5 and the grounding part 6 of the antenna body 2 are positioned at a slightly right position in the middle of the main board 1, about ⅓ of the board width from the right. With reference to FIG. 2, the antenna body 2 further includes a first radiation support arm 9 and a second radiation support arm 10; one end of the first radiation support arm 9 and one end of the second radiation support arm 10 are connected in parallel through a public part 8 to form a whole connected with the feed part 5 and the grounding part 6; the other end of the first radiation support arm 9 extends horizontally along the left side from the public part 8, and is upwards bent in a roundabout manner when arriving at a set length; the other end of the second radiation support arm 10 also extends a certain length along the left side direction from the public part 8, to form an inverted G shape together with the first radiation support arm 9. The second radiation support arm 10 is configured to generate resonance with higher frequency band; the first radiation support arm 9 is configured to generate resonances with junior-high frequency band and low frequency band. The peripheral part of the public part 8 encircles to form a groove 7 between the feed part 5 and the grounding part 6; the position of the groove 7 is at the edge position of the antenna radiation body, and its specific shape and width may be selectively set according to a specific application scenario.

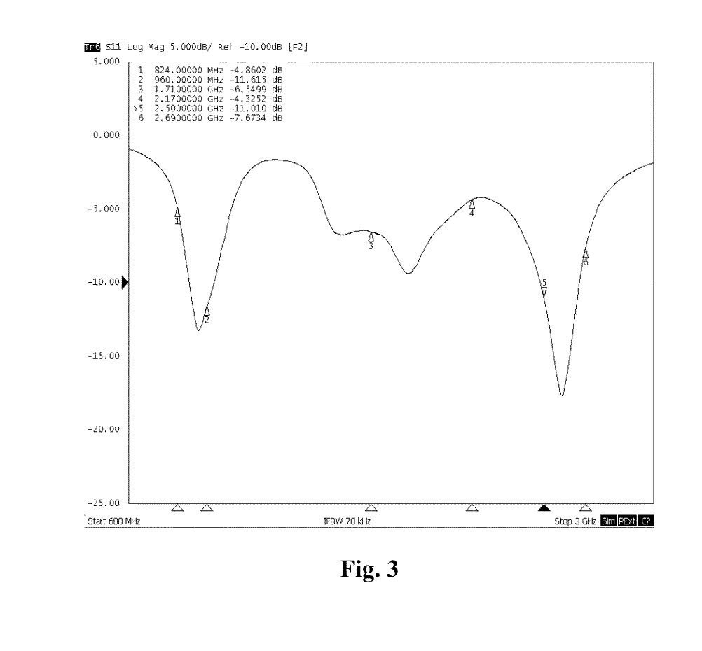

In this embodiment, a gap between the second radiation support arm 8 and a third radiation support arm 7 is set to be about 1 mm; the main tuning frequency band of the antenna as shown in FIG. 2 is set to be 824 MHZ to 960 MHZ, and the high frequency band is set to be 1,710 MHZ to 2,700 MHZ. Under such a condition, please see a diagram of a standing-wave ratio of an antenna as shown in FIG. 3, and see Table I for radiation efficiency of the antenna:

TABLE 1

| Frequency | Efficiency |
|---|---|
| 820000000 | 40% |
| 840000000 | 46% |
| 860000000 | 49% |
| 880000000 | 56% |
| 900000000 | 60% |
| 920000000 | 64% |
| 940000000 | 65% |
| 960000000 | 63% |
| 1710000000 | 35% |
| 1770000000 | 42% |
| 1830000000 | 52% |
| 1890000000 | 55% |
| 1950000000 | 52% |
| 2010000000 | 46% |
| 2070000000 | 39% |
| 2130000000 | 36% |
| 2170000000 | 33% |
| 2500000000 | 54% |
| 2560000000 | 55% |
| 2620000000 | 50% |
| 2680000000 | 40% |
| 2700000000 | 35% |

In the table, the column of Frequency represents a frequency band; the column of Efficiency represents efficiency under each frequency band. It can be seen that the antenna has an extremely good bandwidth in the high frequency band, and the efficiency is above 33% (please see the column of Efficiency in Table I).

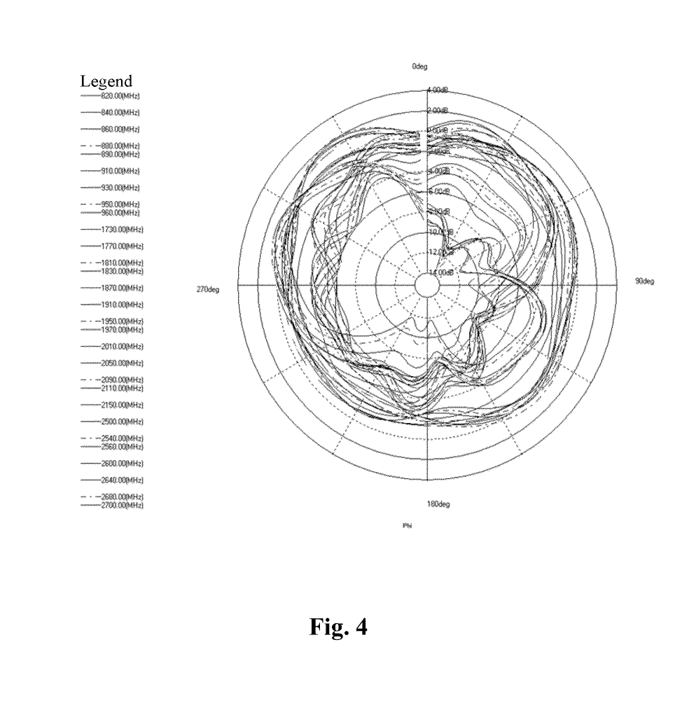

In addition, generally, the radiation H surface in the low frequency band of the antenna is more uniform in directivity. The radiation pattern of a horizontal plane of the antenna as shown in FIG. 2 is as shown in FIG. 4. According to FIG. 4, the low frequency band of the antenna has the greatest radiation between 270 degrees and 360 degrees of the H surface; when a person holds the terminal with the right hand normally, the spherical surface between 270 degrees and 360 degrees is just in the forward direction close to the face, so that the radiation in this direction is enhanced. In this way, loss of whole 3D radiation can be reduced, which means that the Received Signal Code Powder value of the terminal can be increased, and the signal receiving capacity is improved. As a result, the user experience is improved.

The RSCP is an index used for evaluating the capacity of a mobile phone for receiving a signal. Under the same radiation intensity of the base station, if the RSCP value displayed by the mobile phone is larger, the capacity of receiving a signal is higher, and the actual use feeling of a user can be enhanced by improving the receiving capacity of the mobile phone under a weak signal scenario. Meanwhile, the RSCP index is also an important reference technical index for some mobile operators to evaluate the radio frequency performance of the terminal at present. We can check the RSCP value of the mobile phone with the simplest method when holding the mobile phone to check the attenuation value under a free space state. Generally, for a Wideband Code Division Multiple Access (WCDMA), the indexes are as follows:

Good: RSCP>=−85 dBm

Fair: −95 dBm<=RSCP<−85 dBm

Poor: RSCP<−95 dBm

Therefore, the RSCP of a Common Pilot Channel (CPICH) should be greater than −95 dBm, or the CPICH is deemed to be in weak signal coverage.

The antenna as shown in FIG. 2 is applied to a mobile phone terminal in the embodiment, and in a microwave anechoic chamber, an actual use scenario of the user is simulated. The transmitting power of the base station is simulated to −40 dB, and then a comprehensive measurer reads a receiving value, which is the RSCP value, fed back by the mobile phone. At first, the RSCP values of the terminal at four angles 0 degree, 90 degrees, 180 degrees and 270 degrees under a free state are tested, and under the state of 180 degrees, the RSCP values of the comprehensive measurer are respectively read by two holding modes. The two holding modes are modes that are used by the user at ordinary times. Therefore, the test mode can completely reflect the antenna radiation state of the terminal in an actual use process. Table II lists actual test values of the antenna a shown in FIG. 2 of the embodiment, and the main test channel is the WCDMA BANDS 4436 channel.

TABLE 2

| BS = −40 dB | RSCP (dB) | | | |
|---|---|---|---|---|
| Terminal state | 0 degree | 90 degrees | 180 degrees | 270 degrees |
| Free space state | −67 | −68 | −68 | −67 |
| Half-holding of | / | / | −74.4 | / |
| the terminal with | | | | |
| a hand | | | | |
| Full-holding of | / | / | −70.4 | / |
| the terminal with | | | | |
| a hand | | | | |
| Average value of | / | / | −72.4 | / |
| two holding | | | | |
| states | | | | |

The general judgment rule is that if the RSCP value in the free space state is −70 dB and the RSCP value in the holding state is −75 dB, a good state is realized. It can be seen from the above table, the RSCP values of the antenna of the embodiment both in the free space state and the holding state are greater than the judgment standard by 2 dB, that is, the receiving performance and the radiation performance of the antenna are higher, and the satisfaction degree of user experience can be enhanced.

The above contents are to further describe the embodiments of the present disclosure in detail with the specific implementation modes, but not intended to limit the specific implementation of the present disclosure. Those skilled in the art can make a plurality of simple deductions or replacements without departing from the concept of the embodiments of the present disclosure, and those deductions or replacements shall fall within the scope of protection defined by the claims of the present disclosure.

1. An antenna device, comprising an antenna body, wherein the antenna body comprises an antenna radiation body, and a first feed part and a first grounding part which are arranged on the antenna radiation body; the first feed part and the first grounding part are separately arranged on a same side of the antenna radiation body, and a gap between the first feed part and the first grounding part forms a groove configured to adjust a low-frequency bandwidth.

2. The antenna device as claimed in claim 1, wherein the antenna radiation body comprises a first radiation support arm and a second radiation support arm; after being connected in parallel at one ends of the first radiation support arm and the second radiation support arm, the first radiation support arm and the second radiation support arm, as a whole, are connected with the first feed part and the first grounding part respectively; the other ends of the first radiation support arm and the second radiation support arm respectively extend along a same direction.

3. The antenna device as claimed in claim 1, wherein after the other ends of the first radiation support arm and the second radiation support arm respectively extend along the same direction, the first radiation support arm and the second radiation support arm are combined to form an inverted G shape.

4. The antenna device as claimed in claim 3, wherein a trace length of the first radiation support arm is greater than a trace length of the second radiation support arm.

5. The antenna device as claimed in claim 1, further comprising a main board, a radio frequency circuit module arranged on the main board, and a second feed part and a second grounding part which are separately arranged on the main board, wherein the first feed part and the first grounding part are respectively connected with the second feed part and the second grounding part; and the second feed part is connected with the radio frequency circuit module.

6. The antenna device as claimed in claim 5, wherein the second feed part and the second grounding part are arranged in a middle area of two sides of the main board.

7. The antenna device as claimed in claim 6, further comprising a matching circuit module, wherein the second feed part is connected with the radio frequency circuit module through the matching circuit module.

8. The antenna device as claimed in claim 1, wherein a width of the groove is greater than or equal to 0.5 mm and less than or equal to 35 mm.

9. A terminal, comprising an antenna device, wherein the antenna device is arranged in the terminal and comprises an antenna body, wherein the antenna body comprises an antenna radiation body, and a first feed part and a first grounding part which are arranged on the antenna radiation body; the first feed part and the first grounding part are separately arranged on a same side of the antenna radiation body, and a gap between the first feed part and the first grounding part forms a groove configured to adjust a low-frequency bandwidth.

10. The terminal as claimed in claim 9, wherein distances between two sides of the antenna radiation body and two sides of the terminal are greater than 5 mm.

11. The antenna device as claimed in claim 2, wherein a width of the groove is greater than or equal to 0.5 mm and less than or equal to 35 mm.

12. The antenna device as claimed in claim 3, wherein a width of the groove is greater than or equal to 0.5 mm and less than or equal to 35 mm.

13. The antenna device as claimed in claim 4, wherein a width of the groove is greater than or equal to 0.5 mm and less than or equal to 35 mm.

14. The terminal as claimed in claim 9, wherein the antenna radiation body comprises a first radiation support arm and a second radiation support arm; after being connected in parallel at one ends of the first radiation support arm and the second radiation support arm, the first radiation support arm and the second radiation support arm, as a whole, are connected with the first feed part and the first grounding part respectively; the other ends of the first radiation support arm and the second radiation support arm respectively extend along a same direction.

15. The terminal as claimed in claim 9, wherein after the other ends of the first radiation support arm and the second radiation support arm respectively extend along the same direction, the first radiation support arm and the second radiation support arm are combined to form an inverted G shape.

16. The terminal as claimed in claim 15, wherein a trace length of the first radiation support arm is greater than a trace length of the second radiation support arm.

17. The terminal as claimed in claim 9, wherein the antenna device further comprises a main board, a radio frequency circuit module arranged on the main board, and a second feed part and a second grounding part which are separately arranged on the main board, wherein the first feed part and the first grounding part are respectively connected with the second feed part and the second grounding part; and the second feed part is connected with the radio frequency circuit module.

18. The terminal as claimed in claim 17, wherein the second feed part and the second grounding part are arranged in a middle area of two sides of the main board.

19. The terminal as claimed in claim 18, wherein the antenna device further comprises a matching circuit module, wherein the second feed part is connected with the radio frequency circuit module through the matching circuit module.

20. The terminal as claimed in claim 9, wherein a width of the groove is greater than or equal to 0.5 mm and less than or equal to 35 mm.
